(19) United States
(12) Patent Application Publication
(10) Pub. No.: US 2024/0362416 A1
(43) Pub. Date: Oct. 31, 2024

(54) SELF-TEACHING LARGE LANGUAGE MODELS

(71) Applicant: Microsoft Technology Licensing, LLC, Redmond, WA (US)

(72) Inventors: Shima IMANI, Sammamish, WA (US); Harsh SHRIVASTAVA, Redmond, WA (US)

(21) Appl. No.: 18/139,046

(22) Filed: Apr. 25, 2023

(51) Int. Cl. G06F 40/40; G06F 16/332; G06F 40/205

(52) U.S. Cl. CPC G06F 40/40; G06F 16/3329; G06F 40/205

(57) ABSTRACT

The present disclosure relates to methods and systems for self-teaching a large language model (LLM). The methods and systems use a self-learning framework with a plurality of phases. In each phase of the self-learning framework, the LLM generates a diverse set of outputs for a question and an aggregation is performed on the diverse set of outputs generate a phase output. The phase output from a previous phase is used as an input to the LLM in a next phase.

### BACKGROUND

Large language models (LLMs) have become increasingly popular due to their ability to generate fluent and coherent text in response to various input prompts. LLMs continue to face challenges in generating accurate and reliable outputs, often producing false or incorrect information, referred to as hallucinations. This severely affects the reliability and trustworthiness of the LLMs.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes generating, in a first phase by a large language model (LLM), an output for each question in a dataset in response to an input prompt provided to the LLM. The method includes aggregating, in the first phase, the output for each question into a first output. The method includes generating, in a second phase by the LLM, a plurality of outputs for each question in the dataset in response to a plurality of one-shot prompts provided to the LLM, wherein the plurality of one-shot prompts are based on the first output. The method includes aggregating, in a second phase, the plurality of outputs for each question into a second output. The method includes storing the second output with each question in the dataset.

Some implementations relate to a device. The device includes a processor; memory in electronic communication with the processor; and instructions stored in the memory, the instructions being executable by the processor to: generate, in a first phase by a large language model (LLM), an output for each question in a dataset in response to an input prompt provided to the LLM; aggregate, in the first phase, the output for each question into a first output; generate, in a second phase by the LLM, a plurality of outputs for each question in the dataset in response to a plurality of one-shot prompts provided to the LLM, wherein the plurality of one-shot prompts are based on the first output; aggregate, in a second phase, the plurality of outputs for each question into a second output; and store the second output with each question in the dataset.

Some implementations relate to a method. The method includes generating, in a phase of a self-learning framework by a large language model (LLM), a plurality of outputs for a question in response to different input prompts provided with the question to the LLM. The method includes aggregating, in the phase of the self-learning framework, the plurality of outputs for the question into a phase output. The method includes providing the phase output as an input to a next phase of the self-learning framework for use by the LLM.

Some implementations relate to a device. The device includes a processor; memory in electronic communication with the processor; and instructions stored in the memory, the instructions being executable by the processor to: generate, in a phase of a self-learning framework by a large language model (LLM), a plurality of outputs for a question in response to different input prompts provided with the question to the LLM; aggregate, in the phase of the self-learning framework, the plurality of outputs for the question into a phase output; and provide the phase output as an input to a next phase of the self-learning framework for use by the LLM.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for self-teaching a LLM in accordance with implementations of the present disclosure.

FIG. 2 illustrates an example framework for a diversification module and an aggregation module in accordance with implementations of the present disclosure.

FIG. 3 illustrates an example method for self-teaching a LLM in accordance with implementations of the present disclosure.

FIG. 4 illustrates an example method for self-teaching a LLM in accordance with implementations of the present disclosure.

FIG. 5 illustrates components that may be included within a computer system.

### DETAILED DESCRIPTION

Large language models (LLMs) have achieved significant advancements in various natural language processing (NLP) tasks. LLMs refer to machine learning artificial intelligence (AI) models that can generate natural language text based on the patterns they learn from processing vast amounts of data. LLMs use deep neural networks, such as transformers, to learn from billions or trillions of words, and to produce text on any topic or domain. LLMs can also perform various NLP tasks, such as classification, summarization, translation, generation, and dialogue.

LLMs have demonstrated a remarkable ability in generating fluent and coherent text in response to various input prompts (e.g., questions or dialog). However, in some instances, the generated output is not factually correct or in order words, the output hallucinates. A hallucination is the generation of a false or incorrect output of the LLM. For example, an incorrect answer or nonsensical text. This severely affects the reliability and trustworthiness of the LLMs.

The methods and systems of the present disclosure improve the performance and accuracy of LLMs and improve an accuracy of the outputs of the LLMs. The methods and systems use two steps, a diversification step and an aggregation step to improve the accuracy of the outputs of the LLM. The diversification step generates a diverse set of outputs from the LLM given an input prompt. Several techniques may be used by the methods and systems for the diversification step, such as few-shot learning, context manipulation, and adjusting the LLM settings (e.g., temperature setting). The aggregation step combines the outputs to produce a single result. Example aggregation methods include filtering, majority vote, and/or summarization. The methods and systems generate a diverse set of LLM outputs provided by a LLM in response to an input prompt and aggregate the LLM outputs to produce a single, more accurate result. The methods and systems provide a unified perspective on various verification methodologies.

In some implementations, the methods and systems use a self-learning framework that includes a plurality of phases to improve the accuracy of the outputs from the LLM. Each phase of the self-learning framework uses the diversification module and the aggregation module. The output of a previous phase (e.g., the final consensus output from the aggregation module) is provided as the input to the diversification module in a next phase. Each phase of the self-learning framework may improve the accuracy of the outputs of the LLM. In some implementations, the self-learning framework continues to iterate over additional phases of the self-learning framework using the output of a previous phase as an input provided to the diversification module in a next phase. As additional iterations of phases of the self-learning framework are performed, the accuracy of the LLM may continue to improve or the accuracy of the LLM may become stable.

One technical advantage of the methods and systems of the present disclosure is improving an accuracy of LLM predictions. By leveraging the LLM's self-learning capabilities, the methods and systems can improve a performance of the LLM on a wide range of tasks, while also gaining valuable insights into the LLM's internal representations of language. Given a task, the methods and systems of the present disclosure learn overtime to improve the accuracy of the LLM, which helps build trusts with users. Another technical advantage of the methods and systems of the present disclosure is automatically determining which problems the LLM can accurately solve and which problems the LLM is unable to solve with high confidence. Another technical advantage of the methods and systems of the present disclosure is enhancing the reliability and accuracy of the outputs of the LLM in various natural language processing tasks.

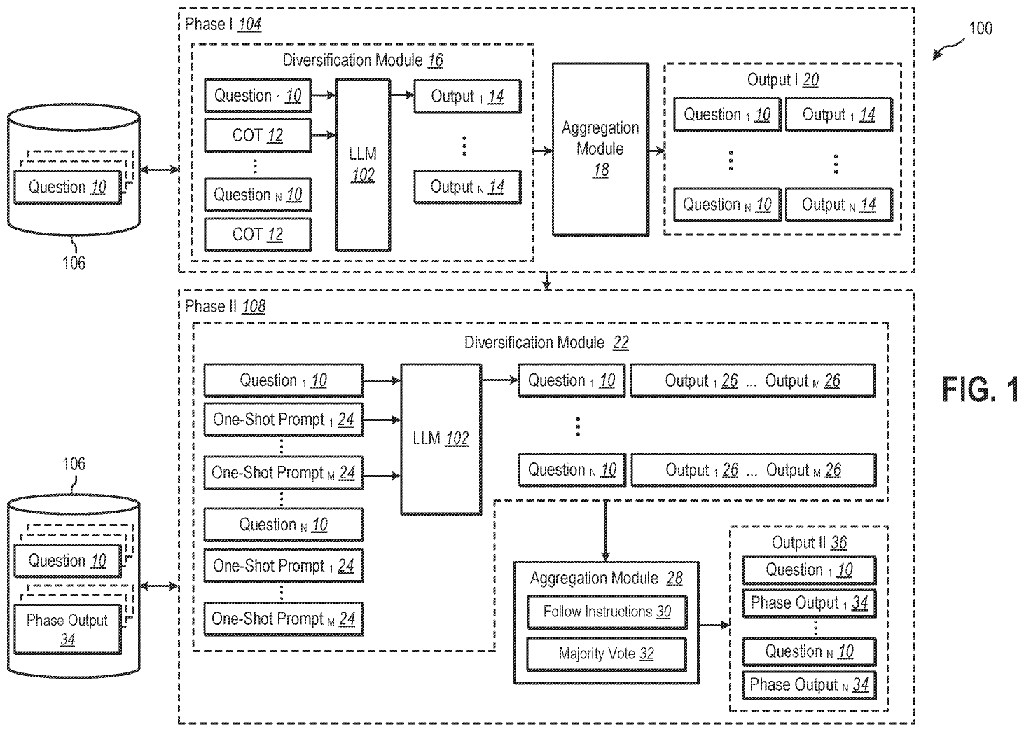

Referring now to FIG. 1, illustrated is an example environment 100 for a self-learning framework to improve the accuracy of a LLM 102 by automatically learning from the LLM's 102 own output to improve the accuracy of the outputs of the LLM 102. Examples of the LLM 102 include GPT-3, BERT, XLNET, AND ELEUTHERAI. The self-learning framework uses the questions 10 in a dataset 106 in an unsupervised manner to improve the accuracy of the LLM 102 to learn from the LLM's 102 own outputs to refine performance of the LLM 102 and improve the accuracy of the outputs of the LLM 102.

The self-learning framework uses a plurality of phases (e.g., the first phase 104 and the second phase 108) to improve the accuracy of the outputs of the LLM 102. The output of a previous phase in the self-learning framework is provided as the input to the LLM 102 of a next phase in the self-learning framework. For example, a first output 20 from the first phase 104 is provided as the input to the diversification module 22 for the second phase 108, and the second output 36 of the second phase 108 is provided as the input to a diversification module for a third phase of the self-learning framework (not shown). While two phases are illustrated, any number of phases may be used by the self-learning framework to improve the accuracy of the outputs of the LLM 102. Each phase of the self-learning framework may improve the accuracy of the outputs of LLM 102.

In some implementations, each phase of the self-learning framework uses two modules, a diversification module (e.g., the diversification module 16 and the diversification module 22) and an aggregation module (the aggregation module 18 and the aggregation module 28). The diversification module generates a diverse set of outputs from the LLM 102 in response to the input prompt. Several techniques may be used by the self-learning framework to generate the diverse set of outputs, such as few-shot learning, context manipulation, and adjusting the LLM settings (e.g., temperature setting).

The aggregation modules (e.g., the aggregation module 18 or the aggregation module 28) decide a final consensus output from the diverse set of outputs obtained from the diversification module. Example aggregation methods include identification, filtering, majority vote, and/or summarization.

In some implementations, the diversification module 16 of the first phase 104 of the self-learning framework the LLM 102 uses a zero-shot chain of thought (COT) method to provide reasoning outputs for each question 10 in the dataset 106. Zero-shot learning is a machine learning approach that enables the recognition of objects or the performance of tasks without having seen any examples of the target class during training. Zero-shot COT involves adding a COT 12 to the input prompt (e.g., the question 10), subsequently generating a sequence of concise statements that emulate the cognitive reasoning process an individual might use when addressing a particular task. Input prompts are the inputs or queries that a user or a program gives to the LLM 102, in order to elicit a specific response from the LLM 102. Prompts can be natural language sentences or questions, or code snippets or commands, or any combination of text or code, depending on the domain and the task. The COT 12 provides a way of thinking as an input prompt to the LLM 102 to break the question 10 into a series of intermediate steps that lead to a final answer for the question 10.

One example of a COT 12 includes “let's think step-by-step.” Another example of a COT 12 includes “first, (*1).” Another example of a COT 12 includes “let's think about this logically.” Another example of a COT 12 includes “let's solve this problem by splitting it into steps.” Another example of a COT 12 includes “let's be realistic and think step by step.” Another example of a COT 12 includes “let's think like a detective step by step.” Another example of a COT 12 includes “let's think 57.58 before we dive into the answer.” Another example of a COT 12 includes “the answer is after the proof. 45.7.”

The diversification module 16 provides the COT 12 and each question 10 up to n (where n is a positive integer) as an input prompt to the LLM 102. The LLM 102 uses the COT 12 to generate an output 14 for each question 10 in the dataset 106. The output 14 includes the answer to the question 10 provided by the LLM 102 and the COT 12 used by the LLM 102 in providing the answer to the question 10.

One example use case includes the following question 10 “Betty is saving money for a new wallet which costs $100. Betty has only half of the money she needs. Her parents decided to give her $15 for that purpose, and her grandparents twice as much as her parents. How much more money does Betty need to buy the wallet?” The COT 12 for this example includes “let's think step-by-step.” The output 14 provided by the LLM 102 for the question 10 in this example is “Betty has $15 from her parents. 2. Betty's grandparents gave her twice as much as her parents, so that's $30. 3. Betty has a total of $45. 4. Betty needs $100 to buy the wallet. 5. Betty needs $55 more to buy the wallet.” The LLM 102 has broken the answer provided in the output 14 into a series of intermediate steps based on the COT 12 provided.

The diversification module 16 generates an output 14 for each question 10 in the dataset 106. The outputs 14 generated by the diversification module 16 are provided to an aggregation module 18. The aggregation module 18 performs an identity matching for each output 14 that pairs the question 10 to the generated output 14 for the question 10. A first output 20 is provided by the aggregation module 18 in response to the identity matching performed. The first output 20 is a question 10, output 14 (answer provided by the LLM 102 for the question 10) pair for all the questions 10 in the dataset 106. In some implementations, the first output 20 is stored (e.g., the question and answer pairs).

The first output 20 of the first phase 104 is provided as input for a second phase 108 of the self-learning framework. In some implementations, the diversification module 22 of the second phase 108 uses one-shot learning to create a plurality of answers for each question 10 in the dataset 106. Few-shot learning allows a model to learn and generalize from a small number of examples, which is helpful when there is limited data for a specific task or class. Unlike zero-shot learning, where the model has not seen any examples of the target class during training, few-shot learning provides the model with a few examples to learn from. One-shot learning provides one example to the model to learn from.

The first output 20 (e.g., the question 10 and the output 14 pairs) are used as the one-shot prompts 24 to provide with the question 10 as an input prompt to the LLM 102. The question 10 and the output 14 pairs generated for the other question 10 in the datastore 106 are reused as the one-shot prompt 24 to provide to the LLM 102 in the second phase 108.

One example use case includes the following one-shot prompt 24 selected from the first output 20. The one-shot prompt 24 includes “Q: James writes a 3-page letter to 2 different friends twice a week. How many pages does he write a year? A: 1. James writes a 3-page letter to 2 different friends twice a week. 2. There are 52 weeks in a year. 3. Therefore, James writes a total of 312 pages a year (3 pages×2 friends×52 weeks).” The one-shot prompt 24 is provided with the question 10 “Q: Betty is saving money for a new wallet which costs $100. Betty has only half of the money she needs. Her parents decided to give her $15 for that purpose, and her grandparents twice as much as her parents. How much more money does Betty need to buy the wallet?” to the LLM 102. The LLM 102 provides the following output 26 for the question 10 based on the one-shot prompt 24 “A: Betty needs $55 more to buy the wallet. She already has $50, and her parents gave her $15, and her grandparents gave her twice as much, which is $30. Therefore, she needs $55 more to buy the wallet.”

In some implementations, a number m (where m is a positive integer) is selected for the number of one-shot prompts 24 to provide for each question 10 in the datastore 106 and the different pairs of questions 10 and outputs 14 are randomly selected from the first output 20 to provide as the one-shot prompt 24. Randomly selecting different pairs of questions 10 and outputs 14 as the one-shot prompt 24, encourages the LLM 102 to produce different responses to the question 10. The question 10 is provided m times to the LLM 102 with a different question 10 and output 14 pair selected for the one-shot prompt 24 for the question 10. The LLM 102 provides m different outputs 26 for each question 10 in the dataset 106.

For example, m is 20 and 20 different question 10 and 20 different outputs 14 are selected from the first output 20 to provide as inputs with the question 10. The LLM 102 provides 20 different outputs 26 for the question 10 based on the different question 10 and different outputs 14 selected as the one-shot prompt 24.

The diversification module 22 generates for each question 10 in the dataset 106, m different outputs 26 based on the m different one-shot prompts 24 provided with the question 10 to the LLM 102. The diversification module 22 generates a diverse set of outputs 26 for the questions 10 without requiring any manually provided one-shot examples as prompts to the LLM 102.

The output of the diversification module 22 (e.g., the m different outputs 26 for each question 10) is provided to the aggregation module 28. The aggregation module 28 aggregates the outputs 26 for the questions 10 to identify a phase output 34 for each question 10. The aggregation module 28 provides a second output 36 in response to the aggregation performed on the outputs 26 for the questions 10. The aggregation module 28 applies different filtering strategies to the outputs 26 to identify a phase output 34 for the question 10.

In some implementations, the filtering strategy includes a follow instructions 30 strategy. The aggregation module 28 removes any outputs 26 that were unable to follow the instructions to the LLM 102 for answering the question 10. The instructions are based on the COT 12 provided to the LLM 102. For example, if the COT 12 is “let's think step-by-step,” the aggregation module 28 keeps any outputs 26 that includes the word “step” (since the LLM 102 followed the instructions in the COT 12) and removes any outputs 26 that do not include the word “step.”

In some implementations, the filtering strategy includes a majority vote 32 strategy. The aggregation module 28 reviews the answers provided in the outputs 26 and keeps the most common answers and removes the outputs 26 with less common answers. The aggregation module 28 keeps the top k (where k is a positive integer) most common answers (e.g., different outputs 26 have the same answer to the question).

For example, if 10 outputs 26 indicated that the answer was $5 for a question 10, 4 outputs indicated that the answer was $55 for a question 10, 1 output indicated that the answer was $15 for a question 10, and one output indicated that the answer was $20 for a question 10, the aggregation module 28 may keep the outputs 26 with the top 2 answers (e.g., $5 and $55) and remove the outputs 26 with other answers (e.g., $15 and $20).

In some implementations, the aggregation module 28 implements both the follow instructions 30 and the majority vote 32 filtering strategies to determine the phase output 34 for the question 10. In some implementations, the aggregation module 28 implements different filtering techniques to identify the phase output 34 for the question 10. For example, the aggregation module 28 uses summarization to filter the outputs 26 and identify the phase output 34. In some implementations, the phase output 34 is stored with the question 10 in the dataset 106.

One example phase output 34 is “A: Step 1: Calculate how much money Betty has. Betty has half of the money she needs for the wallet, which is $50. Her parents gave her $15, and her grandparents gave her twice as much, which is $30. That means Betty has a total of $95. Step 2: Calculate how much more money Betty needs to buy the wallet. Betty needs $100 to buy the wallet. She already has $95, so she needs $5 more. Therefore, Betty needs to save $5 more to buy the wallet.” The phase output 34 incorporates step-by-step reasoning (indicated by the presence of the word “step” in the answer) and the final outcome of $5 represents the majority output.

The aggregation module 28 outputs the second output 36, an updated set of pairs for each question 10 (the question 10 and the phase output 34 for the question 10). The second output 36 produces a phase output 34 (a single, more accurate result) for each of the questions 10 in the dataset 106. The self-teaching frameworks uses the different phases (e.g., the first phase 104 and the second phase 108) to enable the LLM 102 to adapt based on the LLM's 102 own outputs (e.g., the first output 20 and the second output 36) and successively enhance the performance of the LLM 102, resulting in increased accuracy of the outputs of the LLM 102.

In some implementations, the self-learning framework continues to iterate over additional phases using the output of a previous phase as an input provided to the diversification module in a next phase. As additional iterations of phases of the self-learning framework are performed, the accuracy of the LLM 102 may continue to improve or the accuracy of the LLM 102 may become stable.

In some implementations, the self-learning framework is used to answer new questions (e.g., questions not previously in the dataset 106). For example, the self-learning framework performs the second phase 108 and uses the first output 20 from the first phase 104 as the one-shot prompt 24 provided with a new question as the input prompt to the LLM 102. The self-learning framework uses the diversification module 22 to provide a diverse set of outputs 26 for the new question. The aggregation module 28 performs one or more filtering strategies (e.g., the following instructions 30 and/or the majority vote 32) on the phase outputs 26. The aggregation module 28 identifies the phase output 34 for the new question in response to the filtering strategies. The phase output 34 for the new question has increased accuracy since the LLM 102 used better answers (e.g., the first output 20 learned by the LLM 102 for the questions 10 in the dataset) as a model for solving the new question. The second output 36 provided by the aggregation module 28 includes the new question and the phase output 34. Another example includes the self-learning framework using a third phase (not shown) to answer the new question and using second output 36 from the second phase 108 as the input to a diversification module of the third phase with the new question.

The self-learning framework uses the information within the dataset 106 to improve accuracy of the LLM 102 by self-teaching the LLM 102 prompt engineering. The self-learning framework automatically identifies examples based on the information within the dataset 106 for the LLM 102 to use to teach itself to improve the LLM's 102 accuracy at the task at hand.

In some implementations, one or more computing devices (e.g., servers and/or devices) are used to perform the processing of the environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the LLM 102, the dataset 106, and the aggregation module 28 are implemented wholly on the same computing device. Another example includes one or more subcomponents of the LLM 102, the dataset 106, and/or the aggregation module 28 are implemented across multiple computing devices. Moreover, in some implementations, one or more subcomponent of the LLM 102, the dataset 106, and/or the aggregation module 28 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

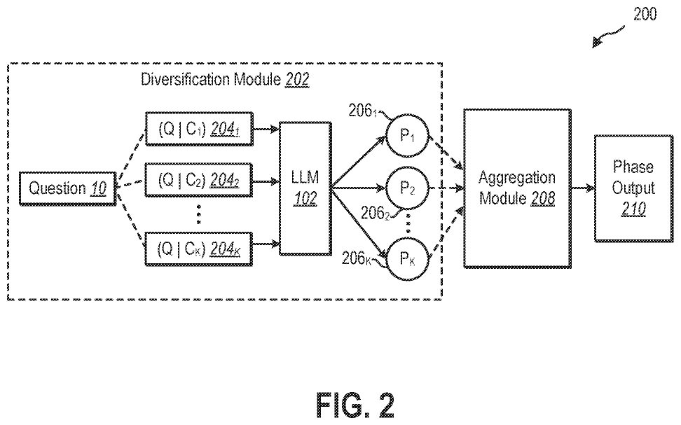

Referring now to FIG. 2, illustrated is an example framework 200 for a diversification module 202 and an aggregation module 208 for use with a self-learning framework to improve the accuracy of the outputs of the LLM 102. The diversification module 202 and the aggregation module 208 may be used in any phase of the self-learning framework (e.g., the first phase 104 (FIG. 1), the second phase 108 (FIG. 1), a third phase, and/or a fourth phase, etc.).

The framework 200 provides a unified framework for the diversification module 202 and the aggregation module 208 that may be chained together to increase a reliability of the LLM 102. A multi-phase (or chaining) of the unified framework (e.g., the diversification module 202 and the aggregation) results in an output of a previous phase (e.g., the phase output 210 provided by the aggregation module 208) provided as an input to the diversification module 202 of a next phase.

The diversification module 202 generates a diverse set of outputs 206 (up to k, where k is a positive integer) for the input prompts 204. The diversification module 202 may use different techniques or approaches to generate a set of diverse outputs 206 for the questions 10. For example, few-shot learning, context manipulation, and/or adjusting the LLM settings (e.g., temperature setting) may be used as part of the input prompts 204 to generate a diverse set of outputs 206 for the question 10.

The question 10 is provided to the LLM 102 with a plurality of input prompts 204 (up to k). In some implementations, the input prompt 204 is the question 10 and different contexts (c) of the LLM settings of the LLM 102. By providing different contexts of the LLM settings in the input prompt 204, the LLM 102 uses different contexts to generate diverse outputs 206 (e.g., P₁ to Pₖ) for the question 10. Different contexts of the LLM settings include different temperature or different input prompts. In some implementations, the input prompt 204 is the output of a previous phase (e.g., the phase output 210) using the diversification module 202 and the aggregation module 208.

An aggregation module 208 decides a final consensus output for the different outputs 206 to produce a phase output 210 for the question 10. Example aggregation methods performed by the aggregation module 208 include filtering, majority vote, and/or summarization. In some implementations, the aggregation module 208 combines portions of the different outputs 206 to product the phase output 210 for the question 10. By combining different outputs 206 into the phase output 210, the aggregation module 208 may improve the accuracy of the answer in the phase output 210 provided by the LLM 102 in response to the question 10. In some implementations, a LLM is used as the aggregation model 208 to analyze the different outputs 206 to produce a phase output 210 for the question 10.

The aggregation module 208 intelligently aggregates the different outputs 206 into a phase output 210, resulting in a more complete reasoning path by the LLM 102 in providing an answer for the question 10. The framework 200 enables the LLM 102 to increase a reliability of the LLM 102 by using the diversification module 202 to generate a diverse set of outputs 206 for an input prompt 204 and using the aggregation module 208 to produce a single more accurate result from the diverse set of outputs 206, enhancing the performance of the LLM 102, resulting in increased accuracy of outputs provided by the LLM 102.

In some implementations, one or more computing devices (e.g., servers and/or devices) are used to perform the processing of the framework 200. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the diversification module 202 and the aggregation module 208 are implemented wholly on the same computing device. Another example includes one or more subcomponents of the diversification module 202 (e.g., the LLM 102) and/or the aggregation module 208 are implemented across multiple computing devices. Moreover, in some implementations, one or more subcomponent of the diversification module 202 and/or the aggregation module 208 may be implemented are processed on different server devices of the same or different cloud computing networks.

In some implementations, each of the components of the framework 200 is in communication with each other using any suitable communication technologies. In addition, while the components of the framework 200 are shown to be separate, any of the components or subcomponents may be combined into fewer components, such as into a single component, or divided into more components as may serve a particular implementation. In some implementations, the components of the framework 200 include hardware, software, or both. For example, the components of the framework 200 may include one or more instructions stored on a computer-readable storage medium and executable by processors of one or more computing devices. When executed by the one or more processors, the computer-executable instructions of one or more computing devices can perform one or more methods described herein. In some implementations, the components of the framework 200 include hardware, such as a special purpose processing device to perform a certain function or group of functions. In some implementations, the components of the framework 200 include a combination of computer-executable instructions and hardware.

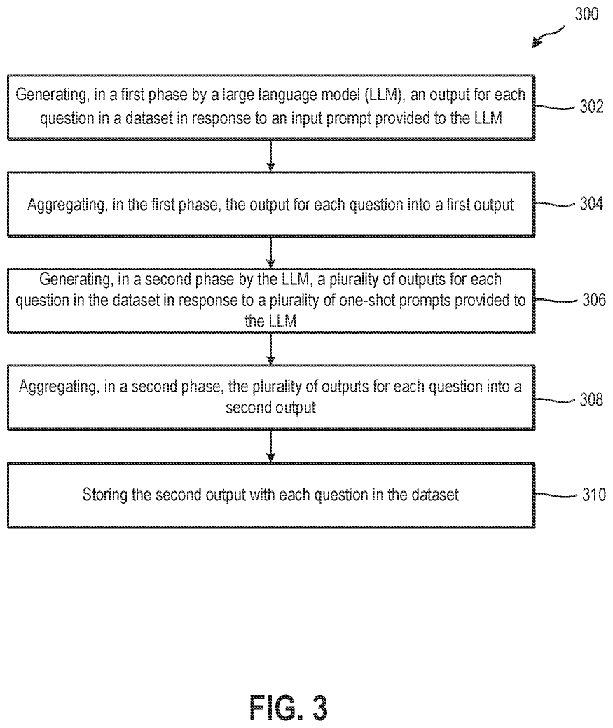

Referring now to FIG. 3, illustrated is an example method 300 for self-teaching a LLM. The actions of the method 300 are discussed below with reference to FIGS. 1 and 2.

At 302, the method 300 includes generating, in a first phase by a LLM, an output for each question in a dataset in response to an input prompt provided to the LLM. In some implementations, the first phase is part of a self-learning framework that improves an accuracy of the LLM 102. The first phase includes a diversification module 16 that generates a diverse set of outputs from the LLM 102 in response to the input prompt. The LLM 102 generates an output 14 for each question 10 in a dataset 106 in response to an input prompt. Several techniques may be used by the diversification module 16 to generate the diverse set of outputs 14 from the LLM 102 in response to the input prompt, such as few-shot learning, context manipulation, and adjusting the LLM settings (e.g., temperature setting).

In some implementations, the input prompt is a COT 12 prompt that breaks a question into a series of intermediate steps that the LLM 102 uses to lead to an answer for the question 10 provided in the output 14. For example, the COT 12 is thinking step by step. The LLM 102 uses the COT 12 to provide reasoning outputs 14 for each question 10 in the dataset 106. The output 14 includes the answer to the question 10 provided by the LLM 102 and the COT 12 used by the LLM 102 in providing the answer (the output 14).

In some implementations, the input prompt (e.g., the input prompt 204) is different contexts and the output 14 for the question 10 is based on the different contexts. By providing different contexts in the input prompt 204 to the LLM 102, the LLM 102 uses different contexts to generate diverse outputs (e.g., the outputs 206 for the question 10). In some implementations, the input prompt is different settings of the LLM 102 and the output 14 for the question 10 is based on the different settings. For example, different settings of the LLM 102 includes different temperature or different input prompts.

At 304, the method 300 includes aggregating, in the first phase, the output for each question into a first output. The first phase includes an aggregation module 18. The outputs 14 generated by the LLM 102 are provided to the aggregation module 18. The aggregation module 18 uses an aggregation method to decide a final consensus of the outputs 14 and provide the first output 20 for the first phase (e.g., the first phase 104). Example aggregation methods include identification, filtering, majority vote, and/or summarization. In some implementations, aggregation module 18 performs an identity matching of the output 14 to a question 10 resulting in a question 10 and answer (the output 14) pair for each question 10 in the dataset 106 as the first output 20.

At 306, the method 300 includes generating, in a second phase by the LLM, a plurality of outputs for each question in the dataset in response to a plurality of one-shot prompts provided to the LLM. The second phase (e.g., the second phase 108) includes a diversification module 22 that generates a diverse set of outputs from the LLM 102 in response to using a plurality of one-shot prompts 24 based on the first output 20. The information from the first output 20 is used for the different one-shot prompts 24 to provide with the question 10 as an input prompt to the LLM 102. For example, the question 10 is provided m (where m is a positive integer) times to the LLM 102 with m different one-shot prompts 24 for the question 10. The LLM 102 provides m different outputs 26 for each question 10 in the dataset 106 in response to the m different one-shot prompts 24. The plurality of outputs 26 provide diverse answers to each question 10.

In some implementations, the plurality of one-shot prompts 24 are different question 10 and answer (the output 14) pairs randomly selected from the first output 20. Randomly selecting different pairs of questions 10 and outputs 14 as the one-shot prompt 24 to provide to the LLM 102, encourages the LLM 102 to produce different responses to the question 10. The plurality of one-shot prompts 24 provide different examples of questions 10 with answers (the output 14) from within the output pair generated in the first phase 104 for the LLM 102 to use in generating the plurality of outputs 26 for each question 10.

At 308, the method 300 includes aggregating, in a second phase, the plurality of outputs for each question into a second output. The second phase includes an aggregation module 28 that receives the plurality of outputs 26 and identifies a phase output 34 for each question 10 from the plurality of outputs 26. The aggregation module 28 provides a second output 36 that includes the phase output 34 in response to the aggregation performed on the outputs 26 for the questions 10. The aggregation module 28 applies different filtering strategies to the outputs 26 to identify a phase output 26 for the question 10. Any combination of filtering strategies or aggregations methods may be used to filter the plurality of outputs 26.

In some implementations, the aggregation module 28 uses a majority of votes 32 filtering to filter the plurality of outputs 26 and the phase output 34 is selected from an answer (one of the outputs 26) for the question 10 with a majority of votes. In some implementations, the aggregation module 28 uses a follow instructions 30 filtering to filter the plurality of outputs 26 based on instructions provided to the LLM 102 for solving the question 10. The phase output 34 is selected from outputs 26 that followed the instructions. In some implementations, the aggregation module 28 is a LLM that generates the second output 36 based on the plurality of outputs 26.

At 310, the method 300 includes storing the second output with each question in the dataset. The second output 36 (e.g., the phase output 34 and the question 10 pair) is stored for each question 10 in the dataset 106.

In some implementations, the method 300 includes using the second output 36 as the input in a next phase of the self-learning framework for use by the LLM 102. The method 300 may include generating, in the next phase by the LLM 102, a plurality of outputs for each question 10 in the dataset 106 in response to a plurality of input prompts provided to the LLM, wherein the plurality of input prompts are based on the second output 36; aggregating, in the next phase by the LLM 102, the plurality of outputs into a phase output; and storing the phase output with each question 10 in the dataset 106.

The method 300 may continue to iterate over any number of phases of the self-learning framework. Each phase of the self-learning framework may improve an accuracy of the outputs provided by the LLM 102. The method 300 generates a diverse set of outputs 26 for the questions 10 by using the previous outputs of the LLM 102 (e.g., the first output 20 of a first phase 104) without requiring any manually provided one-shot prompt examples as prompts to the LLM 102. The method 300 enables the LLM 102 to increase a reliability of the LLM 102 by using the diversification module to generate a diverse set of outputs for an input and using the aggregation module to produce a single more accurate result from the diverse set of outputs, enhancing the performance of the LLM 102, resulting in increased accuracy of outputs provided by the LLM 102.

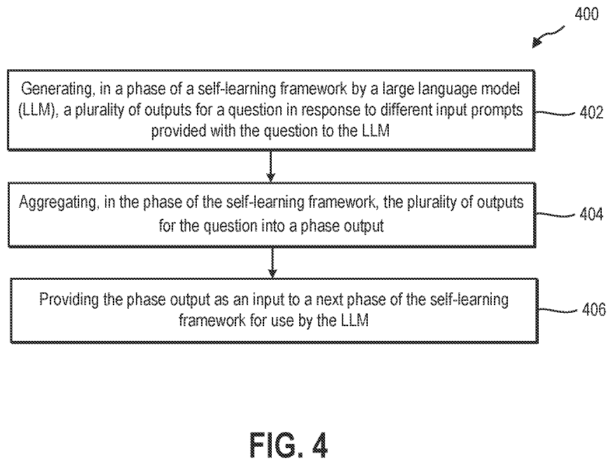

Referring now to FIG. 4, illustrated is an example method 400 for self-teaching a LLM. The actions of the method 400 are discussed below with reference to FIGS. 1 and 2.

At 402, the method 400 includes generating, in a phase of a self-learning framework by a large language model (LLM), a plurality of outputs for a question in response to different input prompts provided with the question to the LLM. The phase may include a framework 200 with a diversification module 202 and an aggregation module 208. The question 10 is provided to the LLM 102 with a plurality of input prompts 204 (up to k) and the LLM 102 generates a plurality of outputs 206 for the question 10 in response to the input prompts 204. The plurality of outputs 206 provide diverse answers to the question 10.

The diversification module 202 may use different techniques or approaches to generate a set of diverse outputs 206 for the questions 10. For example, few-shot learning, context manipulation, and/or adjusting the LLM settings (e.g., temperature setting) may be used as part of the input prompts 204 to the LLM 102 to generate a diverse set of outputs 206 for the question 10.

At 404, the method 400 includes aggregating, in the phase of the self-learning framework, the plurality of outputs for the question into a phase output. The aggregation module 208 decides a final consensus output for the different outputs 206 to produce a phase output 210 for the question 10. Example aggregation methods performed by the aggregation module 208 include filtering, majority vote, and/or summarization.

The aggregation module 208 identifies the phase output 210 from the plurality of outputs 206. Any combination of aggregation methods (e.g., combing portions of different outputs together into a single output, filtering, majority vote, and/or summarization) may be used to produce the phase output 210 for the question 10. The aggregation module 208 intelligently aggregates the different outputs 206 into a phase output 210, resulting in a more complete reasoning path by the LLM 102 in providing an answer for the question 10.

At 406, the method 400 includes providing the phase output as an input to a next phase of the self-learning framework for use by the LLM. The self-teaching frameworks uses the different phases to enable the LLM 102 to adapt based on the LLM's 102 own outputs (e.g., the phase output 210) and successively enhance the performance of the LLM 102, resulting in increased accuracy of the outputs of the LLM 102. The method 400 may further include generating, in the next phase by the LLM, the plurality of outputs for the question in response to using information in the phase output 210 for the different input prompts provided with the question to the LLM. The method 400 may further include aggregating, in the next phase of the self-learning framework, the plurality of outputs into a next phase output. The method 400 may further include providing the next phase output to another phase of the self-learning framework for use by the LLM.

The method 400 may continue to iterate over any number of phases of the self-learning framework, where an output of a previous phase is provided as an input to a next phase of the self-learning framework. Each phase of the self-learning framework may improve an accuracy of the outputs provided by the LLM 102. The diversification module 202 and the aggregation module 208 may be used in any phase of the self-learning framework. The method 400 increases a reliability of the LLM 102 by using the diversification module 202 to generate a diverse set of outputs 206 for an input prompt 204 and using the aggregation module 208 to produce a single more accurate result from the diverse set of outputs 206, enhancing the performance of the LLM 102, resulting in increased accuracy of outputs provided by the LLM 102.

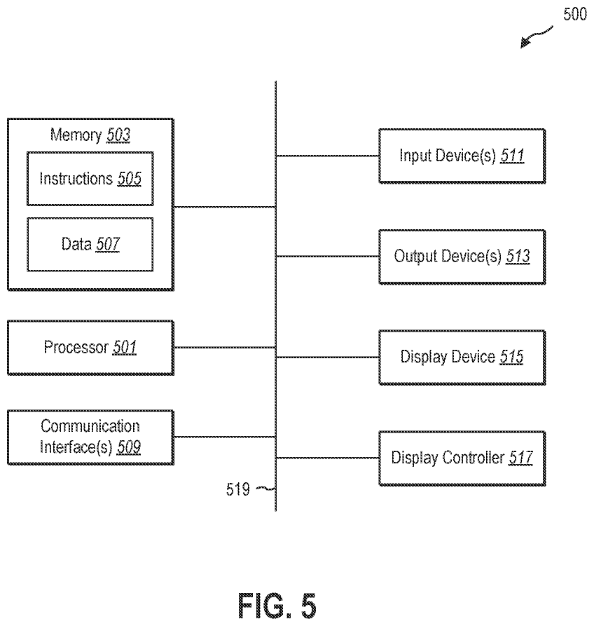

FIG. 5 illustrates components that may be included within a computer system 500. One or more computer systems 500 may be used to implement the various methods, devices, components, and/or systems described herein.

The computer system 500 includes a processor 501. The processor 501 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

In some implementations, the various components of the computer system 500 are implemented as one device. For example, the various components of the computer system 500 are implemented in a mobile phone or tablet. Another example includes the various components of the computer system 500 implemented in a personal computer.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a unknown functions. For example, a machine learning model may refer to a neural network (e.g., a convolutional neural network (CNN), deep neural network (DNN), recurrent neural network (RNN)), or other machine learning algorithm or architecture that classification model, a clustering model, a regression model, a language model, an object detection model) that can be tuned (e.g., trained) based on training input to approximate learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
generating, in a first phase by a large language model (LLM), an output for each question in a dataset in response to an input prompt provided to the LLM;
aggregating, in the first phase, the output for each question into a first output;
generating, in a second phase by the LLM, a plurality of outputs for each question in the dataset in response to a plurality of one-shot prompts provided to the LLM, wherein the plurality of one-shot prompts are based on the first output;
aggregating, in a second phase, the plurality of outputs for each question into a second output; and
storing the second output with each question in the dataset.

2. The method of claim 1, wherein the input prompt is a chain of thought (COT) prompt that breaks a question into a series of intermediate steps that the LLM uses to lead to an answer for the question provided in the output.

3. The method of claim 2, wherein the COT prompt is thinking step by step.

4. The method of claim 1, wherein in the input prompt is different settings of the LLM and the output for a question is based on the different settings.

5. The method of claim 1, wherein the input prompt is different contexts and the output for a question is based on the different contexts.

6. The method of claim 1, wherein aggregating the output includes performing an identity matching of the output to a question.

7. The method of claim 1, wherein the first output includes a question and answer pair for each question in the dataset.

8. The method of claim 7, wherein the plurality of one-shot prompts are different question and answer pairs randomly selected from the first output.

9. The method of claim 7, wherein the plurality of one-shot prompts provide different examples of questions with answers from within the output pair generated in the first phase for the LLM to use in generating the plurality of outputs for each question.

10. The method of claim 1, wherein the plurality of outputs provide diverse answers to each question.

11. The method of claim 1, wherein aggregating the plurality of outputs includes using a majority of votes to filter the plurality of outputs and the second output is selected from an answer with a majority of votes.

12. The method of claim 1, wherein aggregating the plurality of outputs is based on instructions provided to the LLM for solving the question and the second output is selected from outputs that followed the instructions.

13. The method of claim 1, wherein aggregating the plurality of outputs is performed by a LLM to generate the second output.

14. The method of claim 1, wherein the first phase and the second phase are part of a self-learning framework that improves an accuracy of the LLM.

15. The method of claim 1, further comprising:
using the second output as input in a next phase for use by the LLM.

16. The method of claim 15, further comprising:
generating, in the next phase by the LLM, a plurality of outputs for each question in the dataset in response to a plurality of input prompts provided to the LLM, wherein the plurality of input prompts are based on the second output;
aggregating, in the next phase by the LLM, the plurality of outputs into a phase output; and
storing the phase output with each question in the dataset.

17. A method, comprising:
generating, in a phase of a self-learning framework by a large language model (LLM), a plurality of outputs for a question in response to different input prompts provided with the question to the LLM;
aggregating, in the phase of the self-learning framework, the plurality of outputs for the question into a phase output; and
providing the phase output as an input to a next phase of the self-learning framework for use by the LLM.

18. The method of claim 17, further comprising:
generating, in the next phase by the LLM, the plurality of outputs for the question in response to using information in the phase output for the different input prompts provided with the question to the LLM;
aggregating, in the next phase of the self-learning framework, the plurality of outputs into a next phase output; and
providing the next phase output to another phase of the self-learning framework for use by the LLM.

19. The method of claim 17, wherein each phase of the self-learning framework improves an accuracy of outputs provided by the LLM.

20. The method of claim 17, wherein the plurality of outputs provide diverse answers to the question and aggregating the plurality of outputs includes identifying the phase output from the diverse answers.
